(19) United States
(12) Patent Application Publication
(10) Pub. No.: US 2026/0048558 A1
(43) Pub. Date: Feb. 19, 2026

(54) CARBON FIBER FIREARM STOCK

(71) Applicant: MDT Sporting Goods, Chilliwack (CA)

(72) Inventors: Alexander Treit, Chilliwack (CA); Dan Botha, Chilliwack (CA); Ryan Neels, Chilliwack (CA); Brad Neels, Chilliwack (CA)

(21) Appl. No.: 19/304,396

(22) Filed: Aug. 19, 2025

Related U.S. Application Data
(60) Provisional application No. 63/684,559, filed on Aug. 19, 2024.

(51) Int. Cl. B29C 70/06; B29K 75/00; C04B 35/83; F41C 23/18

(52) U.S. Cl. CPC B29C 70/06; C04B 35/83; F41C 23/18; B29K 2075/00

(57) ABSTRACT

A carbon fiber firearm stock, and methods and apparatus for making a carbon fiber firearm stock, including a molded heat-expandable foam core and layer(s) of carbon fiber material molded on the foam core. Expansion of the heat-expandable foam forces the carbon fiber material into apposition with the mold to transfer fine detail areas of the mold to the surface of the carbon fiber firearm stock.

### RELATED APPLICATIONS

This application claims the benefit of U.S. Provisional Application No. 63/684,559, filed on Aug. 19, 2024; which application is incorporated herein by reference in its entirety.

### FIELD OF THE INVENTION

The invention relates to composite firearm stocks and methods of making such products. More specifically, the invention relates to methods, system, and apparatus for making composite firearm stocks, and products made therefrom.

### BACKGROUND ART

Stocks for firearms can be made of numerous types of materials, including wood, plastic, metal, carbon fiber, fiberglass, among other types of materials. Each material can offer associated benefits, reduced weight, increased strength, visual appeal, etc. Of these materials, carbon fiber has become more prevalent over recent years, as a result of the many benefits the material offers. However, one drawback of carbon fiber can be the associated difficulty of laying up the carbon fiber on or in a mold. For example, it can be difficult to obtain intricate and defined details with carbon fiber. Furthermore, it can be difficult to lay carbon fiber in recessed and difficult to reach areas of a stock. Embodiments of the present disclosure can provide solutions to the drawbacks of laying up carbon fiber firearm stocks.

### BRIEF SUMMARY OF THE INVENTION

Embodiments of the present disclosure can include a method for manufacturing a carbon fiber firearm stock. In some embodiments, the method can include placing one or more heat-activated pieces of foam in a foam core mold. In some embodiments, the method can include heating the foam core mold to a first temperature for a first time to generate a foam core. In some embodiments, the method can include removing the foam core from the foam core mold. In some embodiments, the method can include laying up the foam core with heat activated carbon fiber layers to create a carbon fiber laid-up foam core. In some embodiments, the method can include placing the carbon fiber laid-up foam core into a carbon fiber mold. In some embodiments, the method can include heating the carbon fiber mold to a second temperature for a second time to generate the carbon fiber firearm stock.

Embodiments of the present disclosure can include a method for manufacturing a carbon fiber firearm stock. In some embodiments, the carbon fiber firearm stock can include a foam core, wherein the foam core includes variable densities of foam throughout the foam core. In some embodiments, the carbon fiber firearm stock can include a carbon fiber shell, wherein the carbon fiber shell encapsulates the foam core.

These and various other advantages and features of novelty which characterize the present invention are pointed out with particularity in the claims annexed hereto and forming a part hereof. However, for a better understanding of the invention, its advantages and objects obtained by its use, reference should be made to the drawings which form a further part hereof, and to the accompanying descriptive matter, in which there is illustrated and described preferred embodiments of the present invention.

### BRIEF DESCRIPTION OF THE DRAWINGS

In the drawings, in which corresponding reference numerals and letters indicate corresponding parts of the various embodiments throughout the several views, and in which the various embodiments generally differ only in the manner described and/or shown, but otherwise include parts corresponding to the parts in the other various embodiments;

FIG. 1 depicts various tools, components, foam, and templates, in accordance with embodiments of the present disclosure.

FIG. 2A depicts outlines of various foam layers, in accordance with embodiments of the present disclosure.

FIGS. 2B and 2C depict cut out foam layers, in accordance with embodiments of the present disclosure.

FIG. 2D depicts leftover scraps from the foam layers being cut out, in accordance with embodiments of the present disclosure.

FIG. 2E depicts the layers of foam that form the main portion of the firearm stock, in accordance with embodiments of the present disclosure.

FIG. 2F depicts buttstock and forend layers of foam disposed along side the foam that forms the main portion of the firearm stock, in accordance with embodiments of the present disclosure.

FIGS. 2G to 2N depict the addition of additional layers of foam to select portions of the main portion of the firearm stock, in accordance with embodiments of the present disclosure.

FIG. 3A depicts a first portion and second portion of the firearm stock being inserted into respective foam mold first side and foam mold second side, in accordance with embodiments of the present disclosure.

FIG. 3B depicts the insertion of the cheek riser molding insert, into a foam mold first half, in accordance with embodiments of the present disclosure.

FIG. 3C depicts the attachment of the foam mold first half and foam mold second half, in accordance with embodiments of the present disclosure.

FIG. 3D depicts the insertion of an accessory mount foam mold insert such as for an attachment rail, in accordance with embodiments of the present disclosure.

FIG. 4A, depicts the foam core disposed in a foam mold first half, after heating, in accordance with embodiments of the present disclosure.

FIG. 4B depicts release of the foam core from the foam mold first half, in accordance with embodiments of the present disclosure.

FIGS. 5A to 5H depict the wrapping and insertion of a buttstock insert, in accordance with embodiments of the present disclosure.

FIG. 5I depicts addition of additional layers of carbon fiber pieces at a proximal end of the buttstock of the foam core, in accordance with embodiments of the present disclosure.

FIG. 5J depicts the addition of carbon fiber pieces to the recessed area of the bottom of the forend of the foam core, in accordance with embodiments of the present disclosure.

FIGS. 6A and 6B depict the foam care with additional layers of carbon fiber pieces disposed at the proximal end of the buttstock and recessed area of the bottom of the forend, along with insertion of a wrapped buttstock insert, in accordance with embodiments of the present disclosure.

FIGS. 6C to 6H depict a first layer of carbon fiber pieces being wrapped over the foam core, in accordance with embodiments of the present disclosure.

FIGS. 7A to 7M depict layers of carbon fiber pieces being wrapped over a recoil lug recessed area, in accordance with embodiments of the present disclosure.

FIGS. 8A to 8D depict insertion of ARCA rail attachment strips into a carbon fiber mold first half, in accordance with embodiments of the present disclosure.

FIG. 8E depicts the carbon fiber sheet wrapped foam core inserted into the carbon fiber mold first half prior to temporarily closing the carbon fiber mold to check for any carbon fiber pieces being squeezed between the carbon fiber mold first half and the carbon fiber second half, in accordance with embodiments of the present disclosure.

FIGS. 8F to 8H depicts the carbon fiber sheet wrapped foam core after checking for squeezed carbon fiber pieces but prior to insertion into the carbon fiber mold and baking, in accordance with embodiments of the present disclosure.

FIGS. 9A to 9C depict the firearm stock after baking, in accordance with embodiment of the present disclosure.

FIGS. 10A and 10B depict a forend of the firearm stock that is formed with varying densities of foam, in accordance with embodiments of the present disclosure.

FIGS. 11A to 11C depict formation of a buttstock pocket and insertion of a buttstock insert, in accordance with embodiments of the present disclosure.

FIGS. 12A to 12C depict temperature probe holes in the carbon fiber mold, in accordance with embodiments of the present disclosure.

FIG. 13 illustrates elements of methods of manufacturing a carbon-fiber firearm stock, in accordance with embodiments of the present disclosure.

### DETAILED DESCRIPTION OF THE INVENTION

Various embodiments are described herein of various apparatus and/or systems. Numerous specific details are set forth to provide a thorough understanding of the overall structure, function, manufacture, and/or use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

With general reference to the figures, embodiments of the present disclosure can include construction of a firearm stock foam core 58, formed from a foam material 40, which is a heat-activated material that expands when heated to a specific temperature range. The foam material 40 can be foam sheets 42, foam powder (not shown), foam pellets (not shown), foam block (not shown), or a combination thereof, and can include higher-density foam 45a and lower-density foam 45b. In some embodiments, foam pieces 43 are cut from the foam sheets 42, such as by utilizing templates 48. Upon heating of the foam material 40 in a foam core mold or foam mold 50 for a first particular temperature for a first particular time, the foam material 40 can expand, thereby taking the shape of a foam mold cavity 51c of the foam mold 50, forming a foam core 58. After forming and removing the foam core 58 from the foam mold 50, the foam core 58 can be wrapped with ready-to-mold fiber-reinforced sheet material 60, which in embodiments disclosed herein can be carbon fiber sheets 62, which include a sheet molding compound that is heat-activated to adhere the carbon fiber sheets 62 together. In embodiments disclosed herein, carbon fiber pieces 63 are cut from carbon fiber sheets 62, such as by utilizing templates 48. In embodiments disclosed herein, the carbon fiber pieces 63 are cut to shapes that facilitate wrapping of the foam core 58 such as is illustrated in the drawings. The carbon fiber wrapped foam core 66 can be inserted into a second mold, which in embodiments herein can be carbon fiber mold 70, which can be heated to a second particular temperature for a second particular time to cause the foam material 40 to further expand, pressing the carbon fiber sheets 62 into recesses and fine features 72 included in the carbon fiber mold 70 and causing the sheet molding compound to cure and adhere the layers of carbon fiber sheets 62 together.

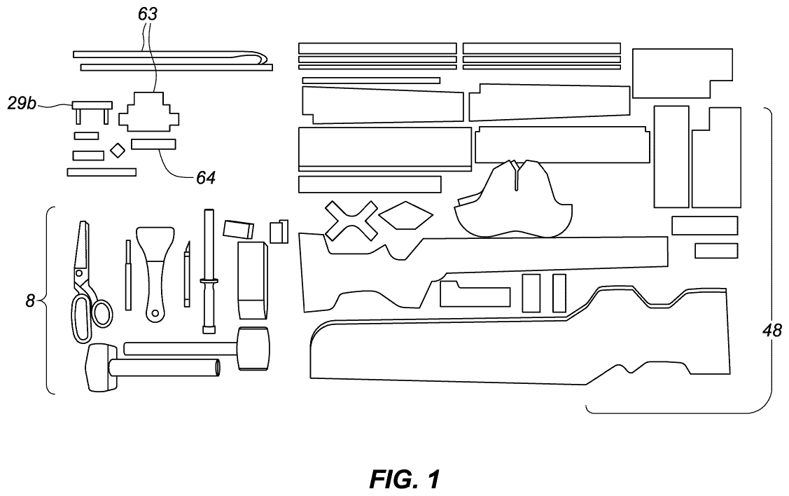

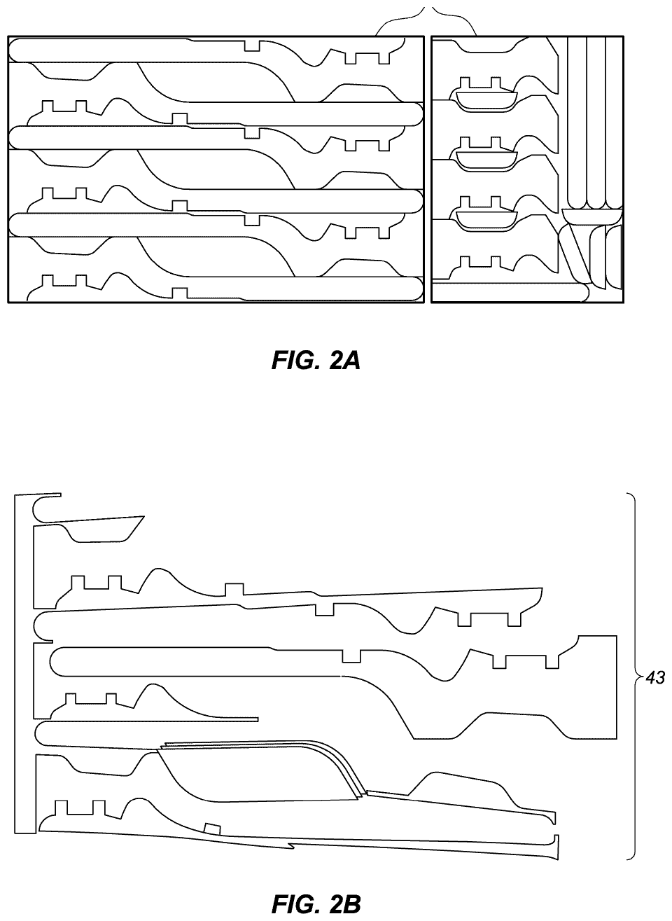

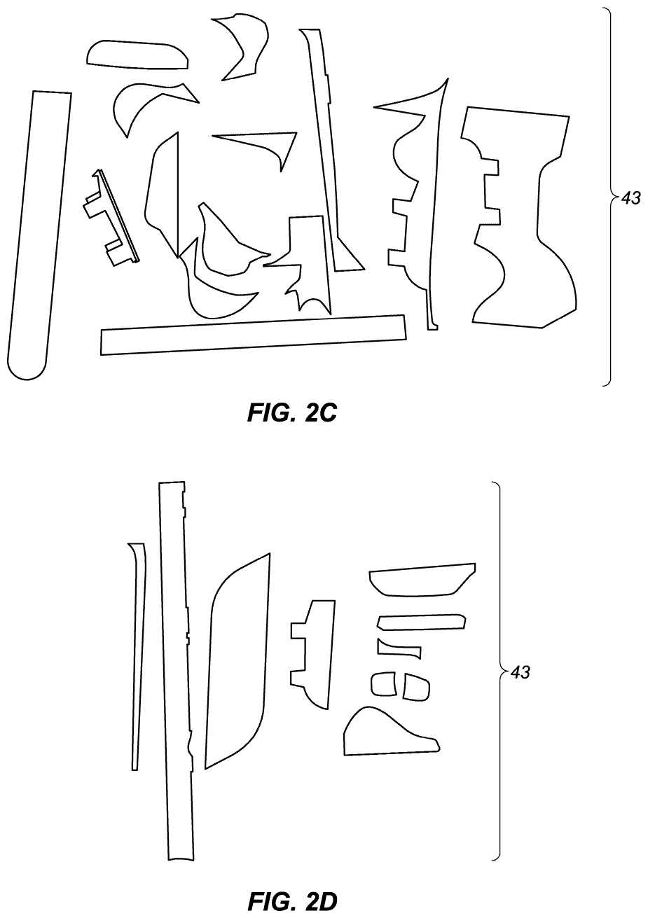

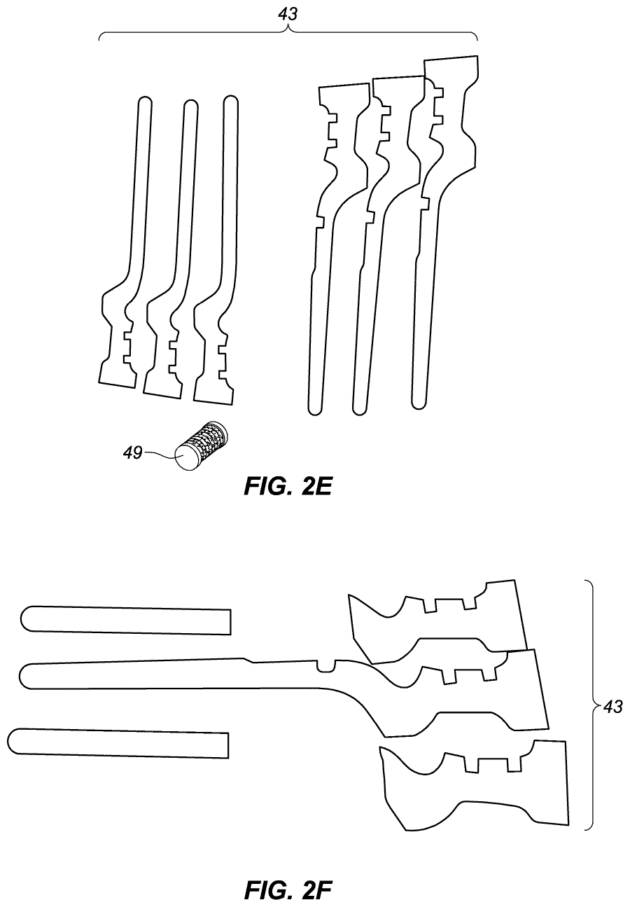

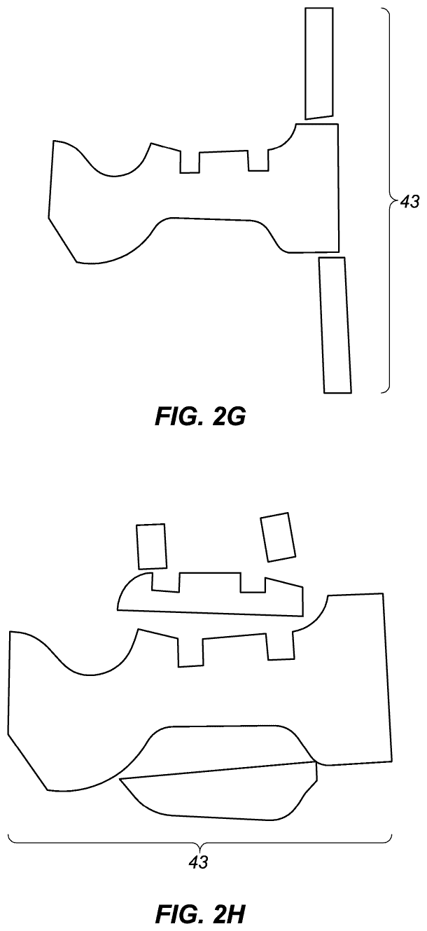

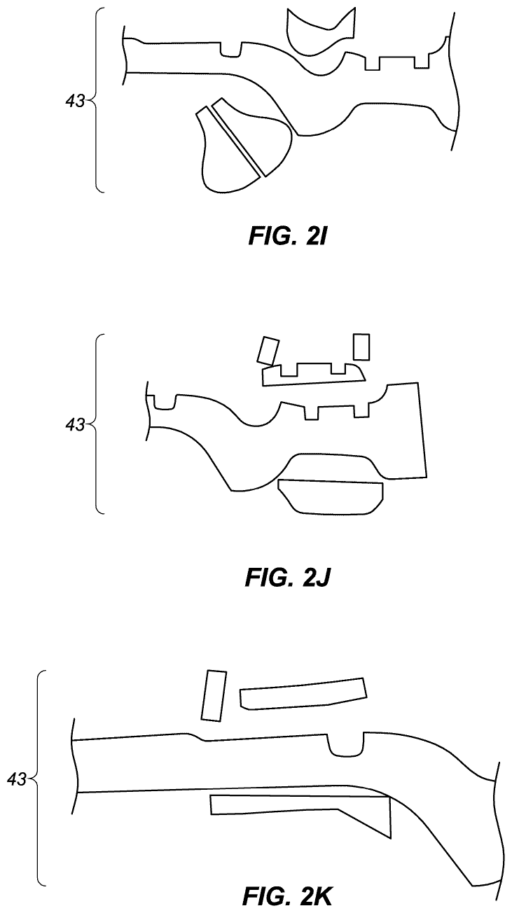

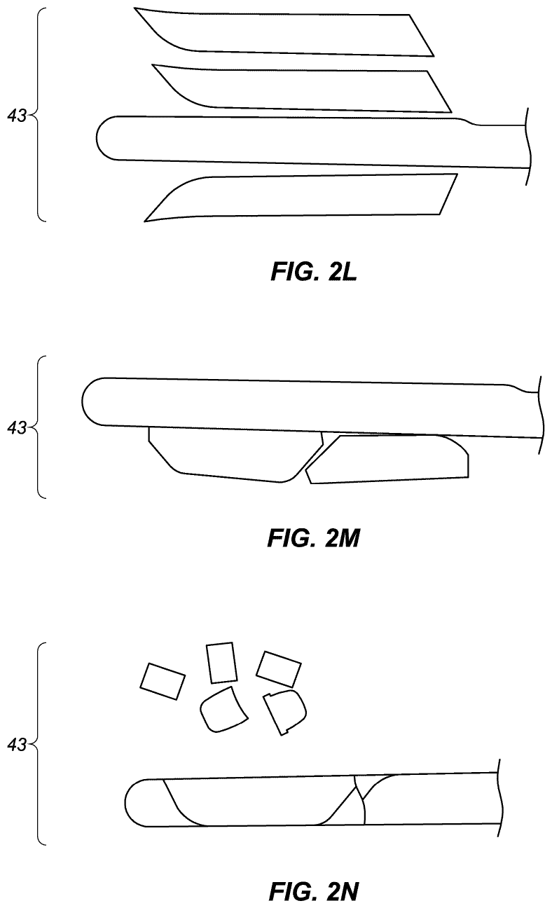

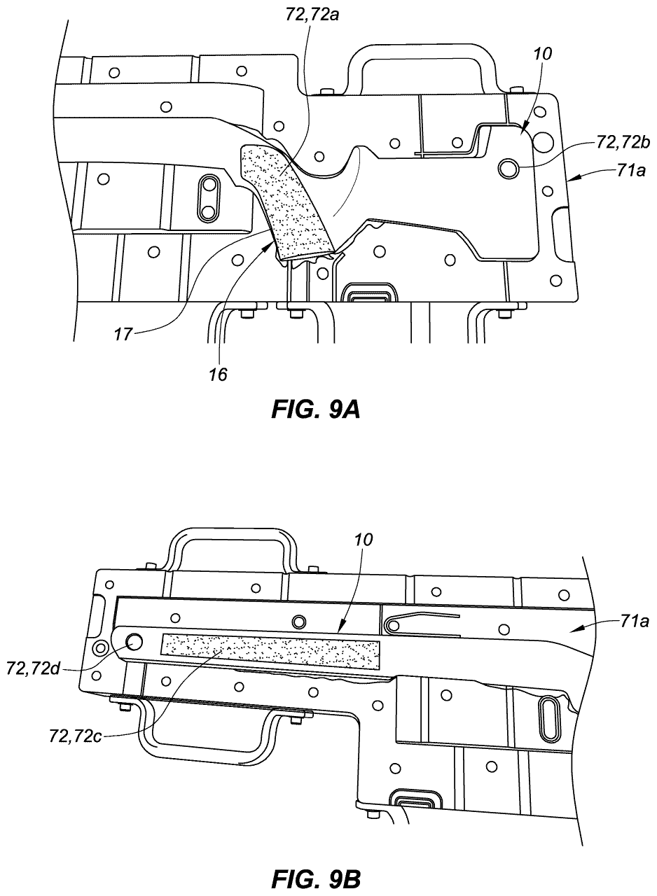

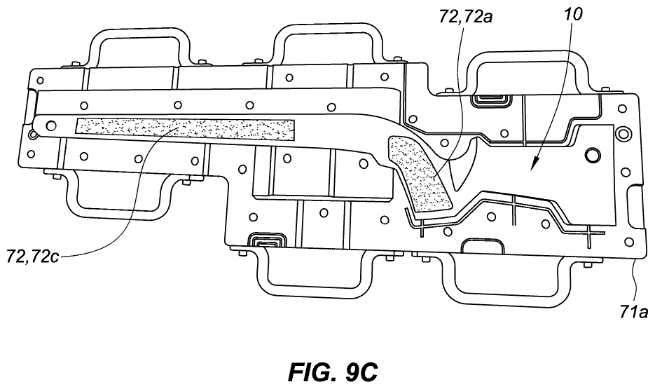

FIG. 1 depicts various tools 8, components, foam material 40, and templates 48 in accordance with embodiments of the present disclosure. Templates 48 can include pattern templates for preparing foam pieces 43 from foam sheets 42 (FIG. 2A), carbon fiber pieces 63 from carbon fiber sheets, and the like. Although the figures illustrate the process for laying up a firearm stock 10 (FIGS. 9A to 11C) for a Remington 700 action, the steps can generally apply to any type of firearm stock 10. As can be seen in FIG. 1, the templates 48 can be used for preparing carbon fiber sheets 62 for a rifle stock. However, embodiments of the present disclosure can be applied to various types of firearms and associated components. Some embodiments of the present disclosure may be applicable to laying up carbon fiber in areas outside of the firearm industry and/or accessories for firearms.

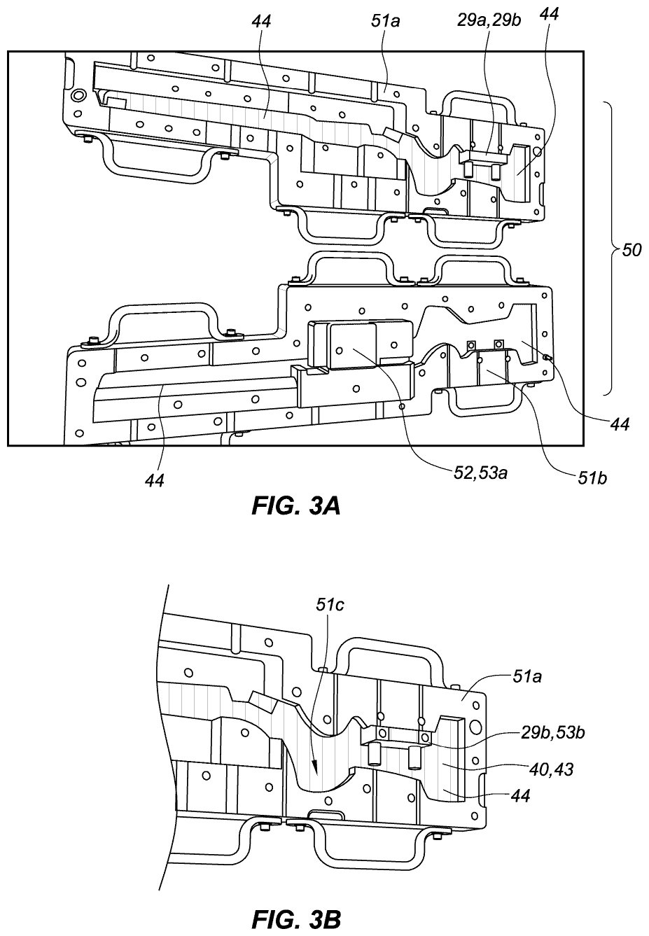

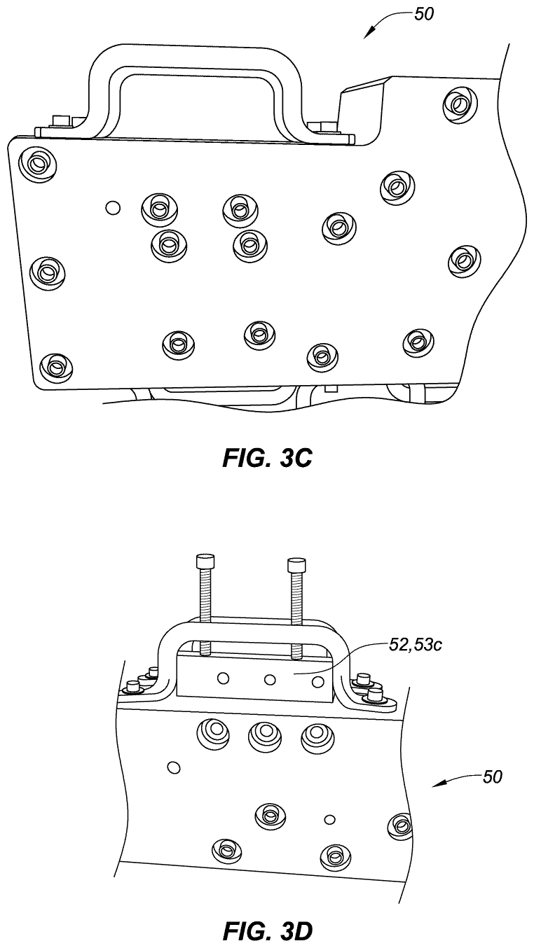

FIG. 2A depicts outlines of various foam sheets 42 to be layed up in accordance with embodiments of the present disclosure; the outlines can be produced using the templates 48, shown in FIG. 1. In some embodiments, the foam material 40 used to form one or more of the various layers can be foam sheets 42 such as Xenecore X-33 foam from Xenecore. In some embodiments, the foam material 40 can be foam powder such as Expancell foam powder from Nouryon. In some embodiments, the foam material 40 can be heat-expandable foam pellets. In some embodiments, instead of or in addition to foam sheets 42, the foam powder, or the foam pellets or a combination can be used and placed into the foam mold 50. In some embodiments, another type of heat-expandable foam can be used and placed in the foam mold 50 (FIG. 3A). In some embodiments, various formulations of the foam material 40 can be used to adjust the expanding temperature of the foam material 40. In some embodiments, when foam sheets 42 are used, the thickness of each of the foam pieces 43 that are bonded together before baking can be approximately 2.5 to 3 millimeters and bonded together with an adhesive 49 (FIG. 2E) to lay up each half as a foam subassembly 44 (FIG. 3A) to be placed into the foam mold 50.

FIGS. 2B and 2C depict the cut-out foam pieces 43 of foam sheets 42 in accordance with embodiments of the present disclosure. In some embodiments, multiple layers of foam pieces 43 can be stacked on top of one another to provide a desired thickness of the foam material 40. In some embodiments, particular areas can include different numbers of layers of foam pieces 43 stacked on top of one another. In an example, the action rails of the firearm (e.g., rifle) stock 10 can include approximately four layers of foam pieces 43, while the buttstock 12 and/or forend 22 of the firearm stock 10 can include approximately 10 layers of foam pieces 43. In some embodiments, a foam block can be machined, cut, or otherwise formed, such that various portions of the foam block can have varying thicknesses, which can then be inserted into the foam mold 50.

In some embodiments, areas of the firearm stock 10 that are of a larger volume (e.g., forend 22, buttstock 12) can include an increased amount of foam material 40, such as a greater number of layers of foam pieces 43 to fill the associated larger volumes. In some embodiments, areas of the firearm stock 10 that have fine features 72 such as more intricate details, texturing, sharper curves, or include deeper recesses, for example, can include an increased number of layers of foam pieces 43, as discussed herein. In an example, providing a greater number of layers of foam pieces 43 can result in a greater density of foam material 40 in the respective areas after the foam material 40 has been expanded. Furthermore, providing a greater number of layers of foam pieces 43 can result in an associated increase in foam expansion force to force the carbon fiber sheets 62 or carbon fiber pieces 63 into those associated areas, which can better produce the fine features 72 on the completed firearm stock 10, for example.

Although embodiments of the present disclosure reference a fiber-reinforced sheet material, such as carbon fiber, in some embodiments, a chopped fiber spray-up can be utilized to build up a fiber coating on the outside of the foam core 58 or on an interior of the carbon fiber mold 71. For example, in some embodiments, a chopped fiber material (e.g., carbon fiber) can be pre-impregnated with an adhesive and sprayed onto the foam mold. Such technique can allow for complex shapes to be more easily coated with the fiber material.

FIG. 2D depicts leftover scraps from the foam pieces 43 being cut out, in accordance with embodiments of the present disclosure. Utilizing excess scraps, additional layers of foam pieces 43 can be stacked on top of one another to create varying thicknesses of foam material 40, while at the same time reducing waste of foam material 40.

FIG. 2E depicts the layers of foam piece 43 that form the main portion of the firearm stock 10, in accordance with embodiments of the present disclosure. In some embodiments, an adhesive 49 (FIG. 2E) can be applied to each layer of foam piece 43 to bond the layers of foam pieces 43 to one another, prior to expanding the foam in an associated foam mold 50.

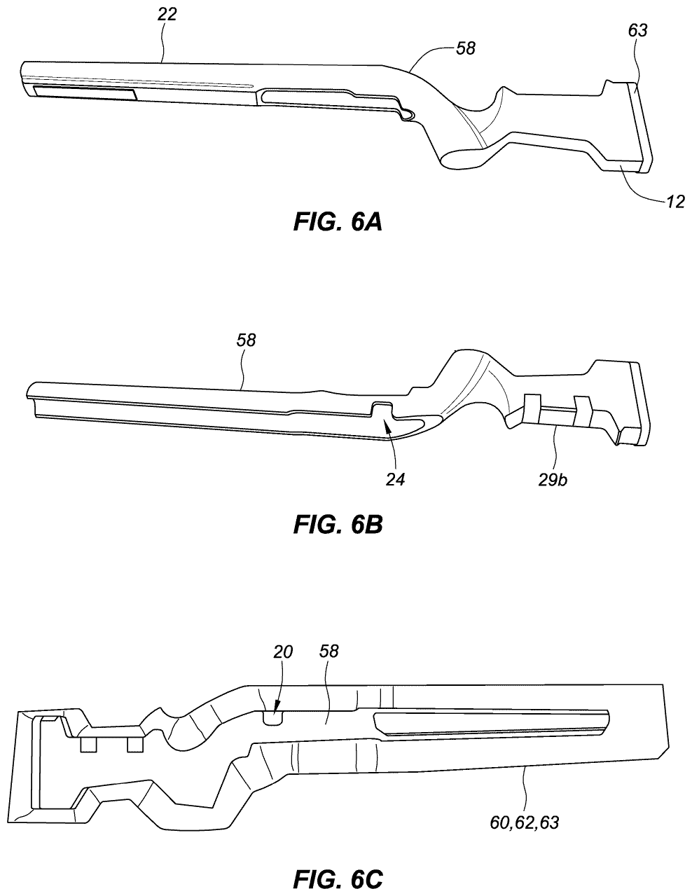

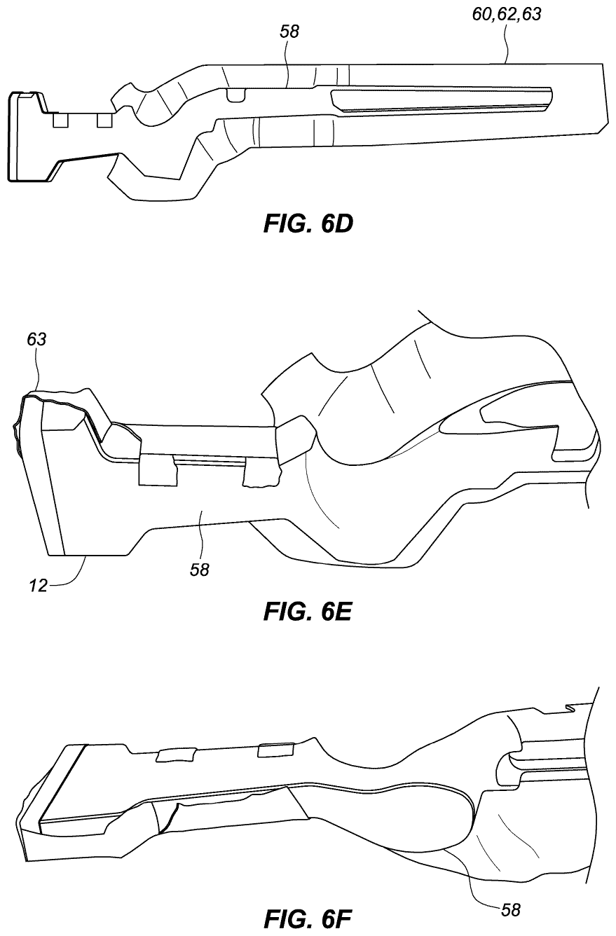

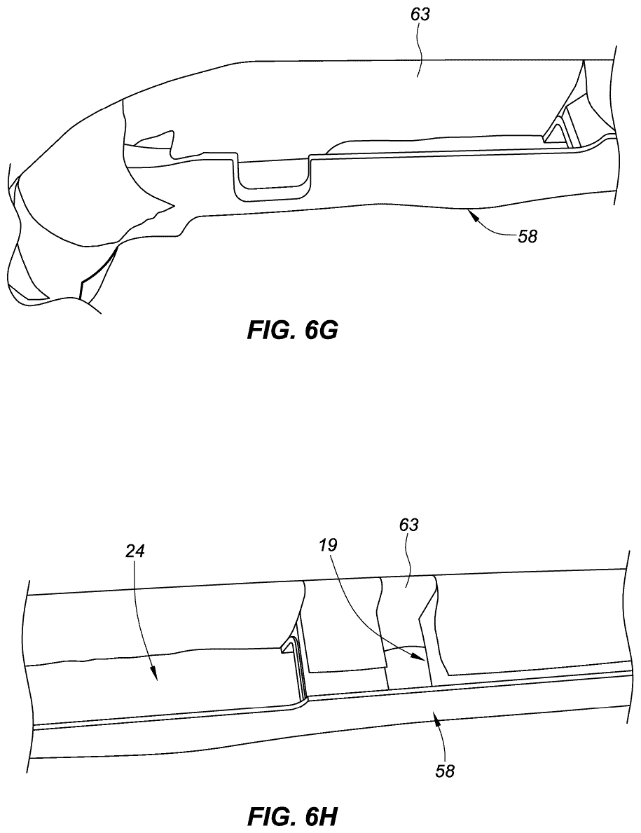

FIG. 2F depicts additional foam pieces 43 for the buttstock 12 (FIG. 6A) and forend 22 (FIG. 6A) of the firearm stock 10 arranged alongside on of the foam pieces 43 that forms the main portion of the firearm stock 10, in accordance with embodiments of the present disclosure. As depicted, additional layers of foam pieces 43 can be adhered to one another in the forend 22 and buttstock 12 regions of the foam core 58.

FIGS. 2G to 2N depict the addition of additional layers of foam pieces 43 to select portions of the main portion of the firearm stock 10, in accordance with embodiments of the present disclosure. In some embodiments, varying numbers of layers of foam pieces 43 can be included in different areas of the foam core 58. As a result, when the foam material 40 is inserted into the foam mold 50 and heated to form a foam core 58, the different areas can expand to varying degrees, thereby providing different densities of foam material 40 in different areas of the foam core 58. When the foam core 58 is wrapped with carbon fiber sheets 62 and/or carbon fiber pieces 63 and further heated, varying degrees of expansion force can be provided in different areas of the firearm stock 10. In some embodiments, higher densities of foam material 40 can be included in areas of the firearm stock 10 that contain fine features, such as tighter bends, curves, recesses, stippling or other texturing, or other types of fine features as depicted or discussed herein, which require greater force to press the fiber-reinforced sheet material 60 (such as carbon fiber sheets 62 and/or carbon fiber pieces 63) into these respective areas. In an example, such areas can include the recoil lug area 19; the recessed bolt handle area 20 in which the bolt action handle (not shown) is disposed in a locked configuration; the palm swell area 17 of the bottom grip 16; textured (e.g., stippled) areas of the forend 22 and bottom grip 16 portions of the firearm stock 10, various curves and recesses of the buttstock 12; the action inlet area 24 of the firearm stock 10; among other areas. In some embodiments, higher densities of foam material 40 can be included along the forend tip 23, top edges of the forend 22, middle section of the forend 22, top tips of the buttstock 12, and/or around a front quick detach mounting portion 26 such as an M-LOC, ARCA or other rail, or other features such as for attaching a bipod support or optics to the firearm stock 10.

FIG. 3A depicts foam material 40 inserted into a foam mold first side or first half 51a and a foam mold second side or second half 51b, in accordance with embodiments of the present disclosure. As depicted, the foam mold 50 can include various molding inserts 52 such as action inlet molding insert(s) 53a, cheek riser molding insert 53b, accessory mount molding insert 53c, and so forth. These molding inserts 52 can be used to form pocket(s) 54 to accommodate various inserts in the completed firearm stock, such as for a buttstock insert 29a, cheek riser insert 29b, or accessory mount insert 29c.

FIG. 3B depicts the insertion of the cheek riser molding insert 53b into a foam mold first half 51a, in accordance with embodiments of the present disclosure. The action inlet molding inserts 53a and the cheek riser molding insert 53b can be included in the foam mold 50 to create negative spaces or pockets 54 in which the firearm action (not shown) and/or buttstock shoulder insert 20 can be inserted into the finished firearm stock 10.

FIG. 3C depicts the attachment of the foam mold first half 51a and the foam mold second half 51b, in accordance with embodiments of the present disclosure.

FIG. 3D depicts the insertion of a molding insert 52, in accordance with embodiments of the present disclosure. In some embodiments, similar to that discussed in relation to the action inlet molding inserts 53a and cheek riser molding insert 53b, a molding insert 52 can be mounted to create a pocket 54 in the foam core. Pocket 54 can be filled with an insert out of carbon, metal, plastic or other material which can be used to machine for example M-LOK slots to mount different accessories on the firearm stock 10.

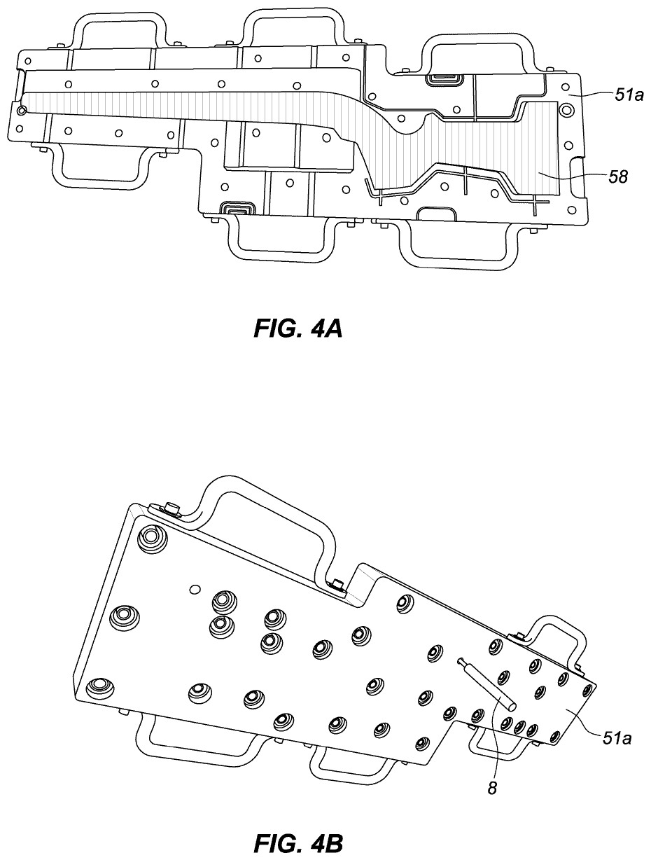

FIG. 4A, depicts the foam core 58 disposed in a foam mold first half 51a after heating, in accordance with embodiments of the present disclosure. In some embodiments, upon connection of the foam mold first side or half 51a with the foam mold second side or half 51b, the foam pieces 43 can be encapsulated inside of the foam mold 50 and the foam mold 50 can be fastened together with, for example, with screws, clamps, bolts, etc. Heating apparatus (not shown), which can include heating plates (not shown), and which can incorporate a heating control apparatus (also not shown) such as temperature and timing measurement and controls to achieve desired temperature and dwell time, is used to expand and cure the foam pieces 43 and form a foam core 58. In some embodiments, once the foam mold 50 is fastened together, the foam mold 50 can be placed between a set of heating plates and can be heated to approximately 135 degrees Celsius and maintained at this temperature for approximately 30 minutes. In some embodiments, the foam mold 50 can be placed between the set of heating plates and heated to a temperature in a range of 120 to 165 degrees Celsius for 20 to 60 minutes. In some embodiments, the heating plates can be placed in direct contact with the foam mold 50, such that the foam mold 50 can be conductively heated. The foam mold 50 can be formed from aluminum, in some embodiments, to ensure rapid conduction of heat from the heating plates to the foam material 40.

In some embodiments disclosed herein, the heating apparatus includes two heating plates can be used, with each heating plate being about 2×40×14 inches in size. Other configurations can be used, as long as the heating apparatus provides the heating required to expand and cure the foam material 40 to produce an acceptable foam core 58 for use in producing a firearm stock 10 according to the present disclosure. In some embodiments, each heating plate can be heated by a cartridge heater, such as a 8×¾ inch diameter cartridge heater with a power of 500 watts at 480 volts, for example. In some embodiments, the heating apparatus can allow the heating plates to be heated to above 250 degrees Celsius. In some embodiments of the present disclosure, the heating plates can be heated to 245 degrees Celsius. In some embodiments, degree to which the heating plates are heated can be dependent on the temperature at which the foam placed therein expands.

FIG. 4B depicts release of the foam core 58 from the foam mold first half 51a, after heating, in accordance with embodiments of the present disclosure. Access holes, punch 8, or other known elements can be incorporated and utilized to aid in release of the foam core 58 from the foam mold 50.

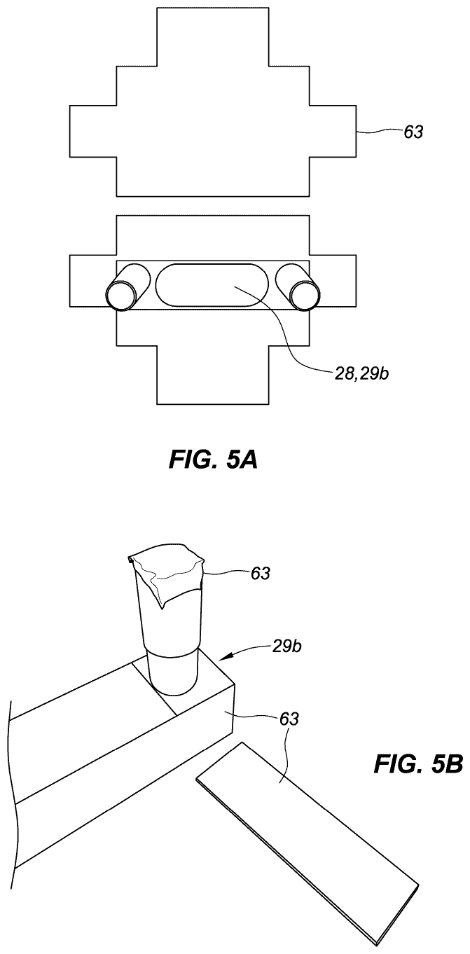

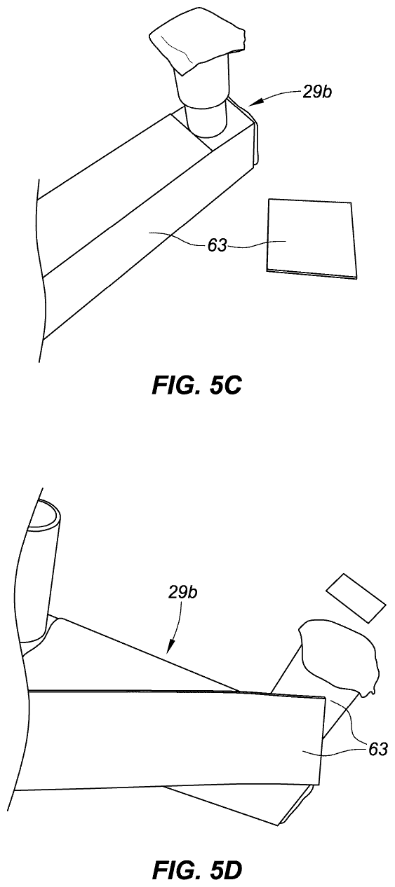

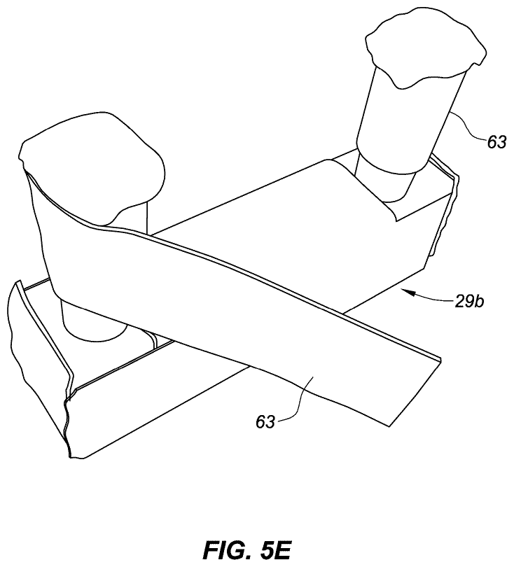

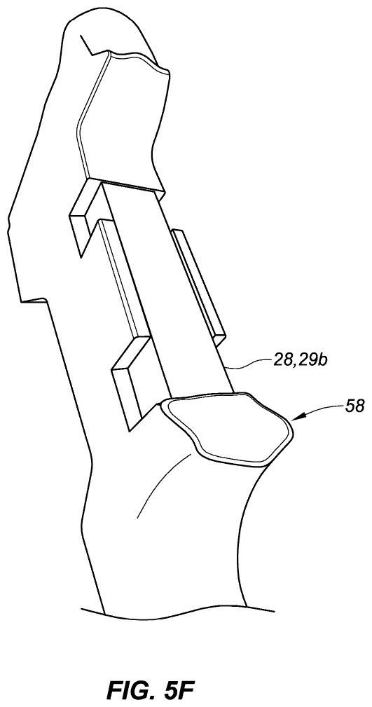

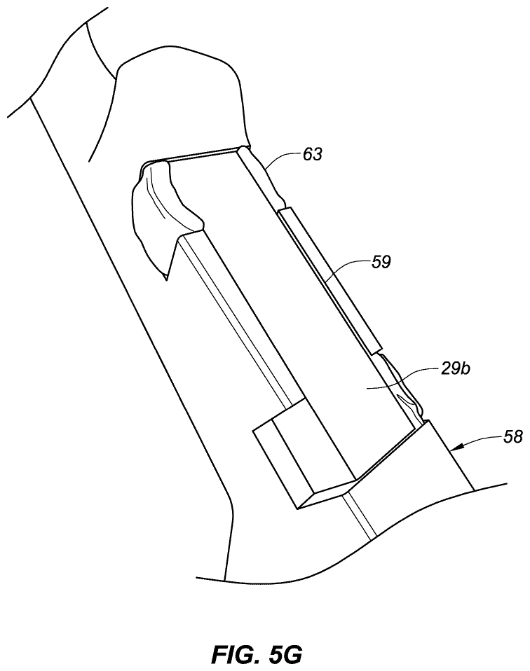

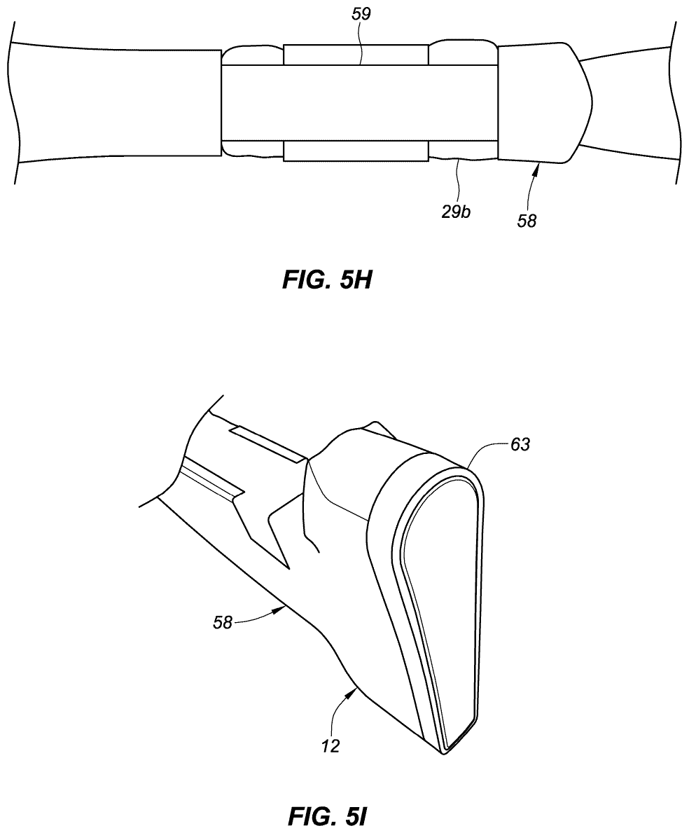

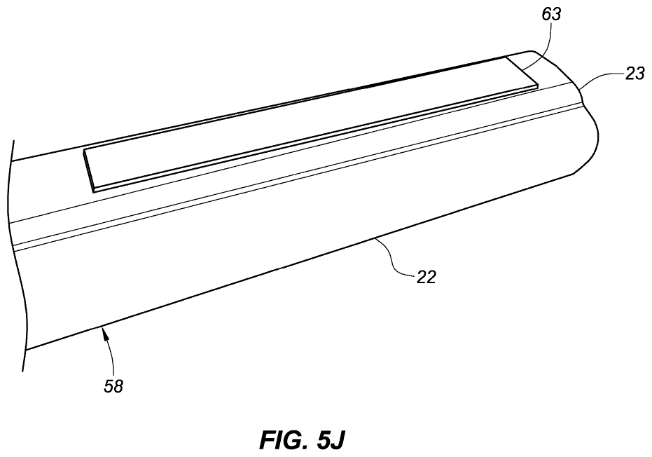

FIGS. 5A to 5H depict the wrapping and insertion of a comb or cheek riser insert 29b, which can provide for an adjustable comb portion of the firearm stock 10, in accordance with embodiments of the present disclosure. In some embodiments, the cheek riser insert 29b can be formed from a metal, such as aluminum, and can be wrapped in carbon fiber pieces 63. Wrapping the cheek riser insert 29b in carbon fiber pieces 63 allows for the aluminum thereof to be encapsulated in carbon fiber and eventually bonded to an interior of the carbon fiber shell of the rifle stock. For example, upon wrapping of the aluminum with carbon fiber, the cheek riser insert can be inserted into a cheek riser slot 59 formed in the foam core 58. As depicted in FIG. 5G, carbon fiber pieces 63 can be inserted into recesses defined on one or more sides of the foam core 58. The mentioned carbon fiber pieces inserted into the recesses can be formed by folding a number of layers of carbon fiber material on top of itself to provide an increased overall thickness. Upon eventual wrapping of the entire assembly including the foam core 58, the cheek riser insert 29b and corresponding carbon fiber pieces inserted into the recesses defined on the one or more sides of the foam core 58, the entire assembly can be bonded together through the adhesive included in the heat activated carbon fiber layers.

FIG. 5I depicts addition of additional carbon fiber pieces 63 at a proximal end of the buttstock 12 portion of the foam core 58, in accordance with embodiments of the present disclosure. In some embodiments, increased numbers of layers of carbon fiber pieces 63 can be included in portions of the firearm stock 10. For example, as depicted in FIG. 51, additional layers of carbon fiber pieces 63 can be wrapped around a proximal end of the buttstock 12. In some embodiments, this can be performed so that additional fiber-reinforced sheet material 60 is present in this region, such that a pocket 54 can be machined that will accommodate a polymer insert that can be glued in afterwards, such as for a buttstock shoulder insert 18. Since attachment of the polymer insert and the fiber-reinforce sheet material 60 can be more secure than attachment of the polymer insert to the foam material 40 of the foam core 58, a greater thickness of fiber-reinforced sheet material, with more layers of carbon fiber pieces, is desirable to be able to machine the pocket 54 and provide for secure attachment of the polymer insert, such as the buttstock shoulder insert 18.

FIG. 5J depicts the addition of carbon fiber pieces 63 to the recessed area of the bottom of the forend 22 portion of the foam core 58, in accordance with embodiments of the present disclosure. In some embodiments, additional layers of carbon fiber pieces 63 can be included in the recessed area of the bottom of the forend 22. Upon curing and completion of the firearm stock 10, the additional layers of carbon fiber pieces 63 can be machined to create features that can include an attachment rail or front quick detach mounting portion 26, such as an M-LOK rail or KeyMod rail. In some embodiments, the additional layers of carbon fiber pieces can be included in the recessed area of the bottom of the forend 22 to provide an area of increased thickness to which a rail can be mounted.

FIGS. 6A and 6B depict the foam core 58 with additional layers of carbon fiber pieces 63 disposed at the proximal end of the buttstock 12 and recessed area of the bottom of the forend 22, along with insertion of the carbon fiber wrapped cheek riser insert 29b, in accordance with embodiments of the present disclosure.

FIGS. 6C to 6H depict a first layer of fiber-reinforced sheet material 60, such as a carbon fiber piece 63, being wrapped over the foam core 58, in accordance with embodiments of the present disclosure. In some embodiments, the carbon fiber sheet 62 can be Prepreg Axiom 5201XL, produced by Axiom Materials. In some embodiments, the heat expandable foam material 40 and the heat activated carbon fiber sheets 62 can cure at approximately the same temperature.

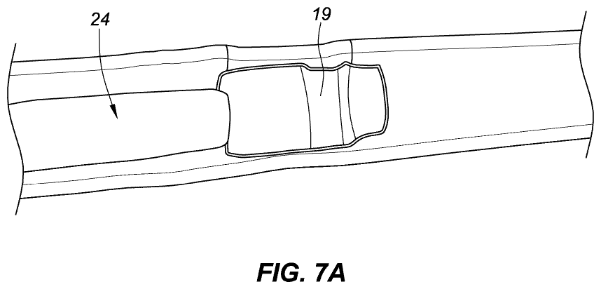

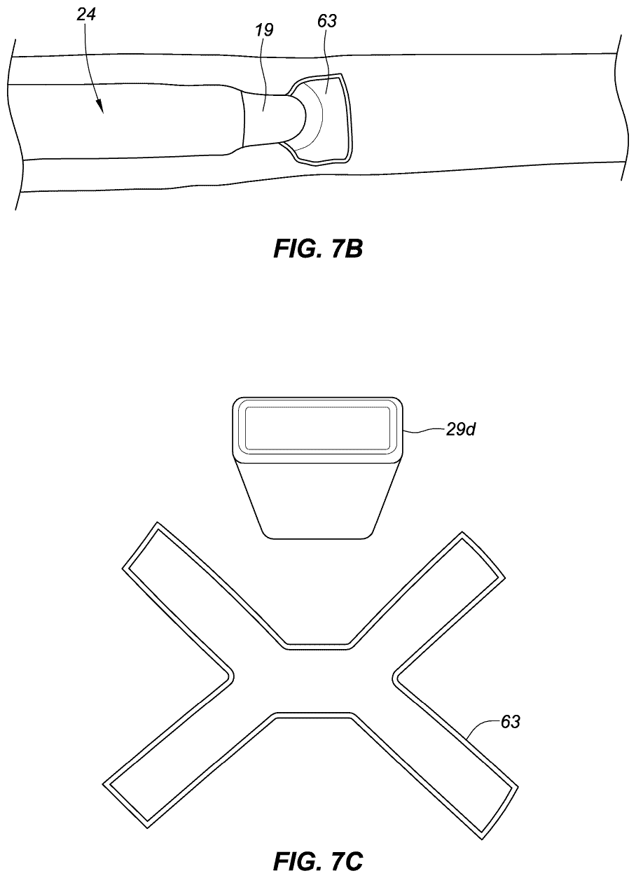

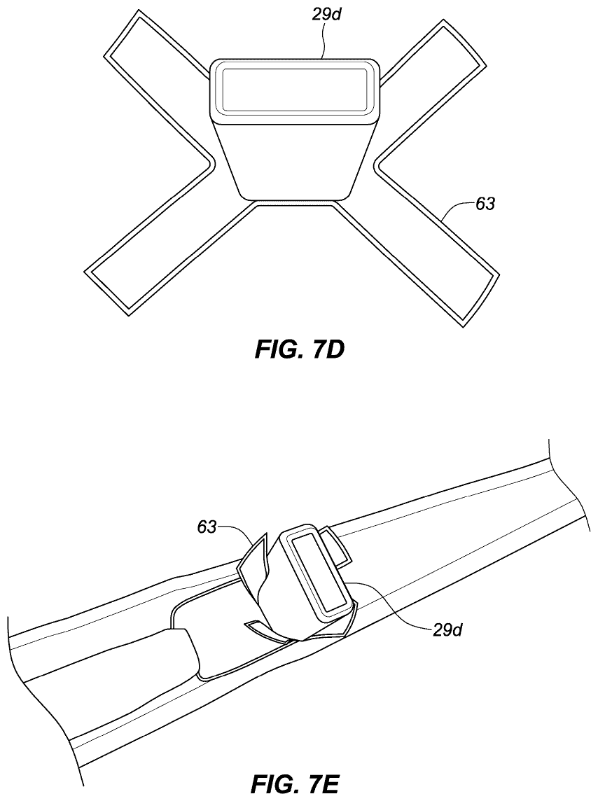

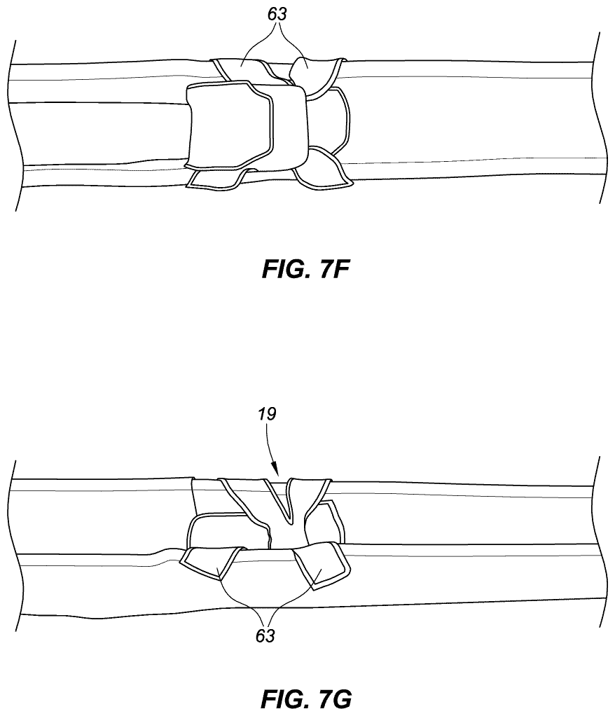

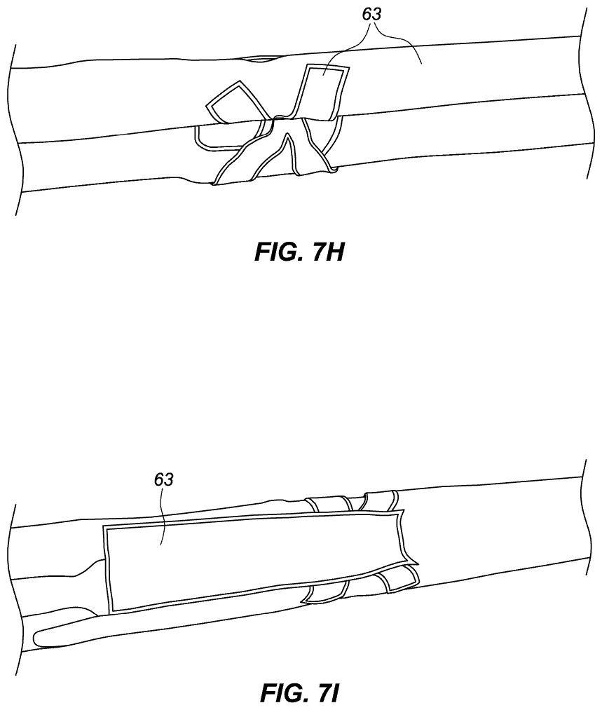

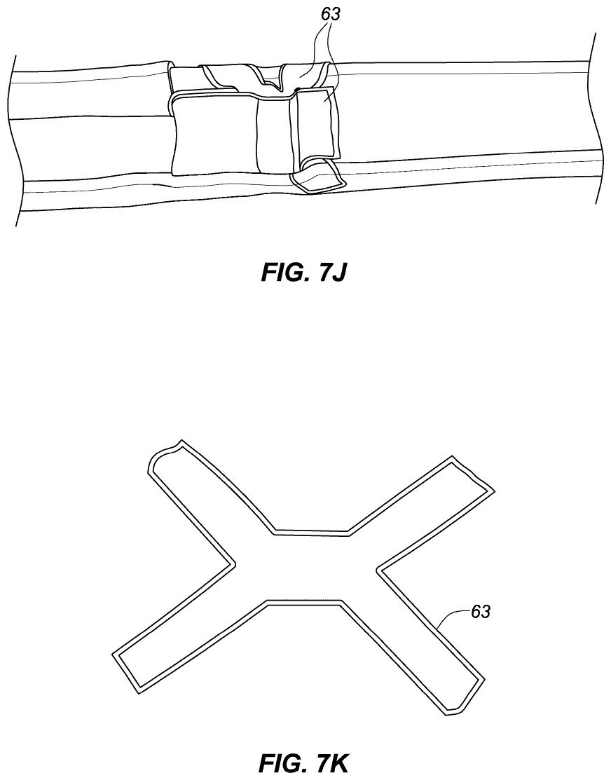

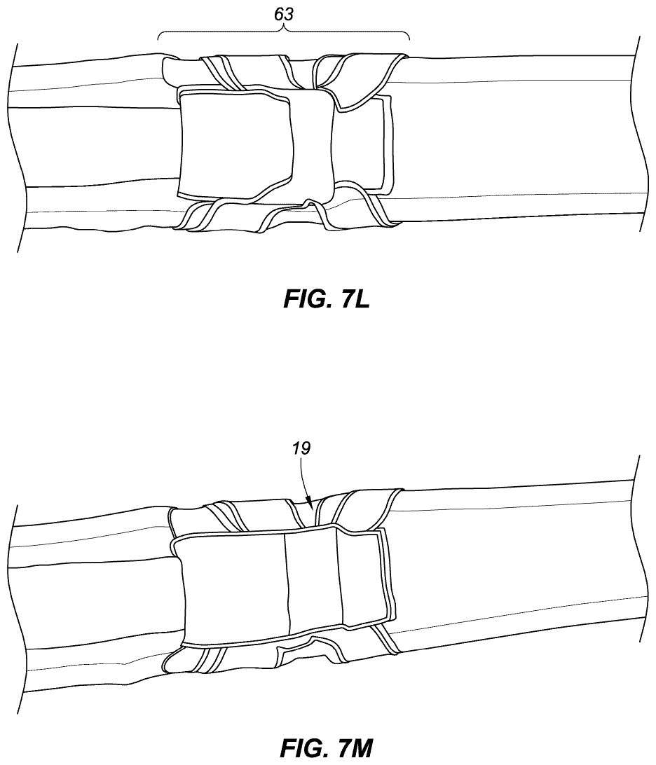

FIGS. 7A to 7M depict layers of carbon fiber pieces 63 being wrapped over the recessed recoil lug area 19, in accordance with embodiments of the present disclosure. In some embodiments, an x-shaped pattern of carbon fiber pieces 63 can be disposed in the recesses of the recoil lug area 19 using the recoil lug insert 29d. An x-shaped carbon fiber piece 63 can allow for the intersecting area of the arms of the x-shape to be disposed in the bottom of the recess that defines the recoil lug area 19. The arms of the x-shape can emanate from the intersecting area and extend across each recessed corner of the recoil lug area 19. As depicted, additional layers of carbon pieces 63 can be disposed over the x-shaped carbon fiber piece 63.

In some embodiments, the arms of the x-shaped carbon fiber piece 63 can cover underlying seams between other layers of carbon fiber pieces 63. In some embodiments of the present disclosure, each underlying seam between carbon fiber pieces 63 can be covered by at least two layers of carbon fiber pieces 63 on top of the underlying seam. In an example, an underlying seam can be defined as a seam that is located adjacent to the foam core 58 and the covering layers of carbon fiber pieces 63 can be disposed over the exterior of the seam, on the side of the seam located opposite from the foam core. By covering each underlying seam with at least two layers of carbon fiber pieces 63, the foam material 40 can be prevented from squeezing out of the underlying seam when the foam core 58 expands in the final curing process.

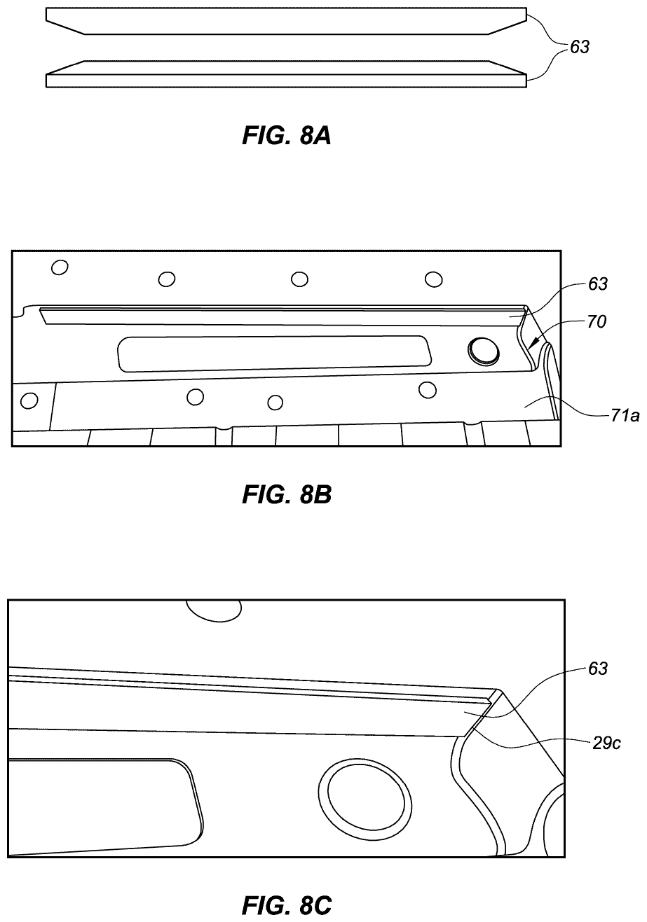

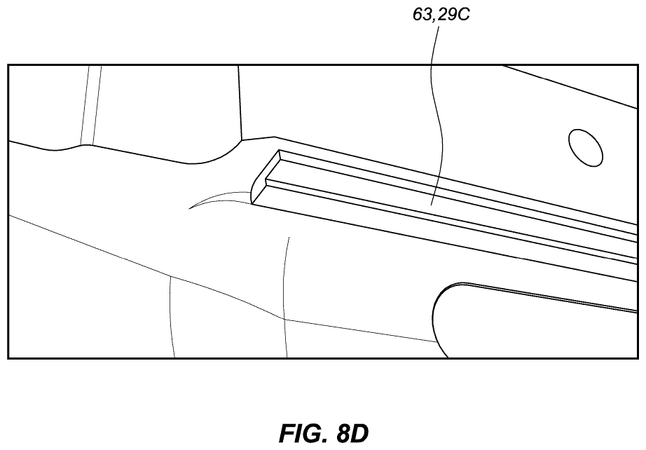

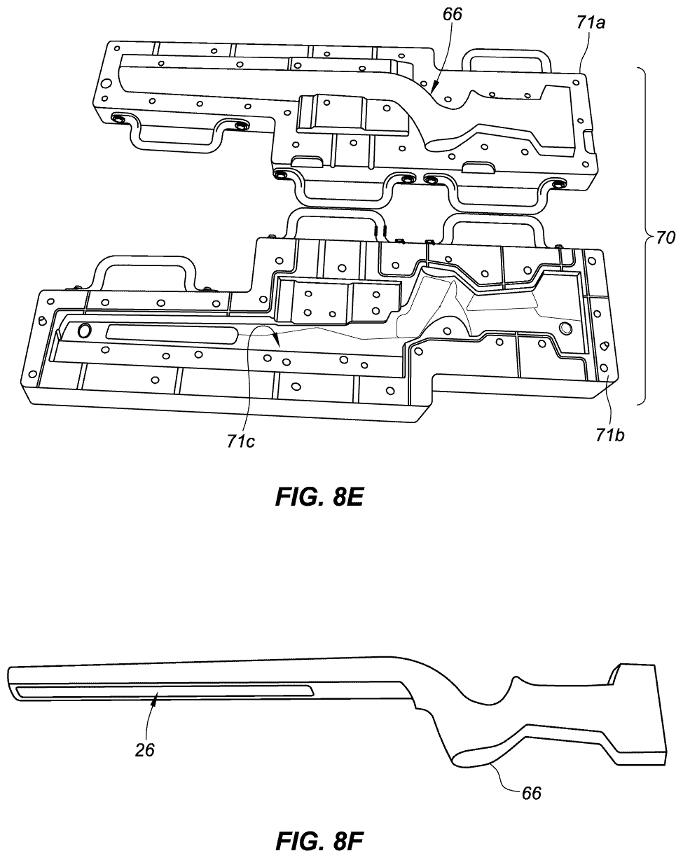

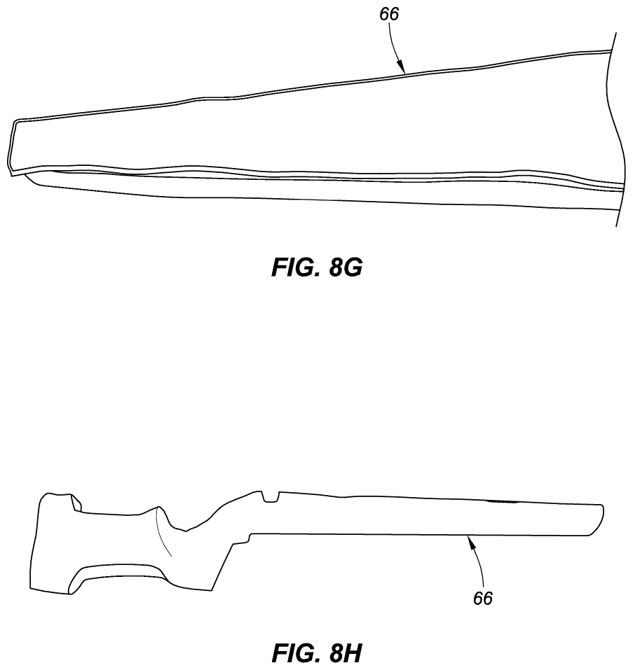

FIGS. 8A to 8D depict insertion of ARCA rail attachment strips of carbon fiber pieces 63 into a carbon fiber mold first half 71a, in accordance with embodiments of the present disclosure. As referenced, in embodiments disclosed herein, the carbon fiber mold 70 includes a carbon fiber mold first side or first half 71a and a carbon fiber mold second side or second half 71b, and defines a carbon fiber mold cavity 71c. In some embodiments, the ARCA rail attachment can include a first rail strip of carbon fiber piece 63 that is disposed in the carbon fiber mold first half 71a and a second rail strip that is disposed in the carbon fiber mold second half 71b. Utilizing an ARCA rail attachment formed from the first rail strip and second rail strip can better allow placement of the first and second rail strips into the carbon fiber mold 70. In some embodiments, a cosmetic layer of carbon fiber sheet 62 can also be disposed over the existing layers of carbon fiber pieces 63 to cover exposed seams, thereby providing a uniform and visually appealing look to the carbon fiber firearm stock 10.

FIG. 8E depicts separation of the carbon fiber mold first half 71a and carbon fiber mold second half 71b of the carbon fiber mold 70 after attachment of the ARCA rail attachment strips of carbon fiber pieces 63, in accordance with embodiments of the present disclosure. The carbon fiber mold 70 can be a different mold than the foam mold 50. In some embodiments, the carbon fiber mold 70 can have increased dimensions over those of the foam mold 50 to allow space for the carbon fiber pieces 63 to be laid up over the foam core 58. In some embodiments the foam mold 50 can be of a smaller interior dimension than the carbon fiber mold 70, such that a carbon fiber wall thickness of 1.75 mm can be formed all the way around the firearm stock. However, in some embodiments, the actual wall thickness of the firearm stock can vary, based on the number of layers of carbon fiber pieces 63. For example, the firearm stock 10 can have from 3 to 8 layers of carbon fiber pieces 63, resulting in a thickness after baking the carbon fiber sheet wrapped foam core 66 in the carbon fiber mold 70 of 0.75 to 2 millimeters, although a thickness of the carbon fiber sheet can be less than or smaller than the provided range. As further depicted in FIG. 8E, areas of the carbon fiber mold 70 such as the forend 22 area and the bottom grip 16 area can include textured areas (e.g., stippling), which can be transferred to the exterior of the carbon fiber firearm stock 10. Embodiments of the present disclosure can force the heat activated carbon fiber pieces 63 into the intricate details associated with the textured areas, as a result of the high pressures associated with the heat activated expanding foam, providing for a greater level of detail than what was previously capable with rifle stocks formed from fiber-reinforced sheet material (e.g., carbon fiber).

FIG. 8F depicts the carbon fiber sheet wrapped foam core 66 prior to insertion into the carbon fiber mold 70 and heating, in accordance with embodiments of the present disclosure. In some embodiments, the carbon fiber sheet wrapped foam core 66 can be placed in the carbon fiber mold first half 71a of the carbon fiber mold 70 first and the carbon fiber mold 70 closed for a period of time and then the carbon fiber sheet wrapped foam core 66 can be placed in the carbon fiber mold second half 71b of the carbon fiber mold 70 and closed for a period of time (in some embodiments, the sides can be reversed). By closing the carbon fiber mold 70 on the carbon fiber sheet wrapped foam core 66, a visual check can be made for pinched or squeezed carbon fiber pieces 63, uneven seams, and uniformity in the processes performed to each side of the carbon fiber sheet wrapped foam core 66 can be ensured, which can be beneficial in obtaining consistency between each side of the firearm stock 10. In embodiments disclosed herein, the carbon fiber pieces 63, for example, include pre-impregnated sheet molding compound that provides a degree of adhesion or tackiness to hold the carbon fiber pieces 63 in place prior to heating in the carbon fiber mold 70. In some embodiments disclosed herein, a plurality of carbon fiber pieces 63 are assembled to form a subassembly prior to placement in the carbon fiber mold 70. This adhesion can be facilitated by environmental conditions such as ambient temperature, such as a temperature above about 24 degrees Celsius.

In some embodiments, during a final curing process of the firearm stock 10, the carbon fiber mold 70 can be disposed between heating plates that provide conductive heating to the carbon fiber mold 70. The carbon fiber mold 70 can be formed from aluminum, in some embodiments, to ensure rapid transfer of heat from the heating plates, through the carbon fiber mold 70, and into the layers of carbon fiber pieces 63 and the foam core 58. It can be important to utilize conductive heating to ensure rapid heating of the foam core 58 and layers of carbon fiber pieces 63. In some embodiments, the heating apparatus can include an oven (not shown). Testing has shown that placement of the carbon fiber mold 70 into a convective oven can take approximately 2 hours to heat the foam core 58 and the carbon fiber sheet wrapped foam core 66 to the requisite temperature. However, use of heating plates in direct contact with the respective foam mold 50 or carbon fiber mold 70 (e.g., heating by direct conduction) can take approximately 5 minutes to heat the foam core 58 and the carbon fiber sheet wrapped foam core 66 to the requisite temperature.

In some embodiments, increasing the temperature of the carbon fiber sheet wrapped foam core 66 in the carbon fiber mold 70 too slowly can cause degradation of the heat-activated adhesive that is used to bond the layers of carbon fiber pieces 63. Thus, the adhesive in the

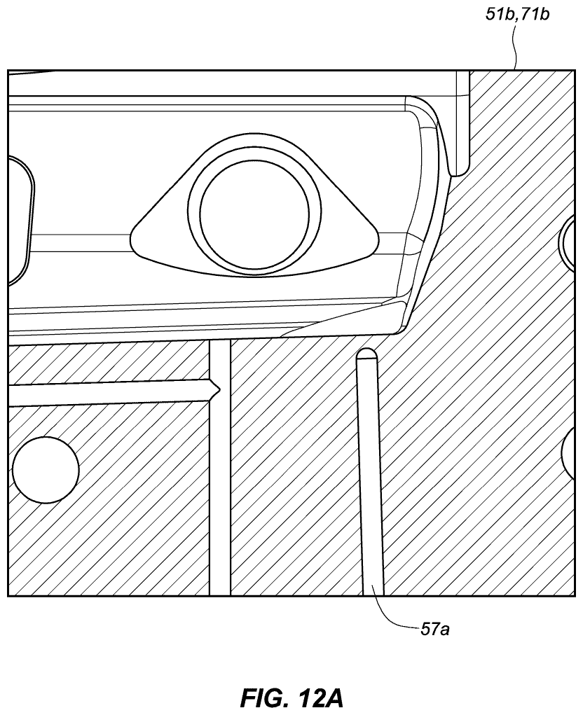

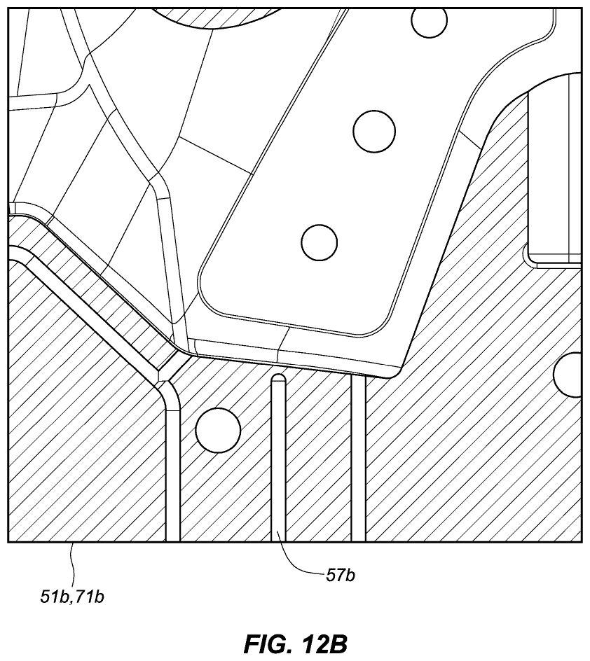

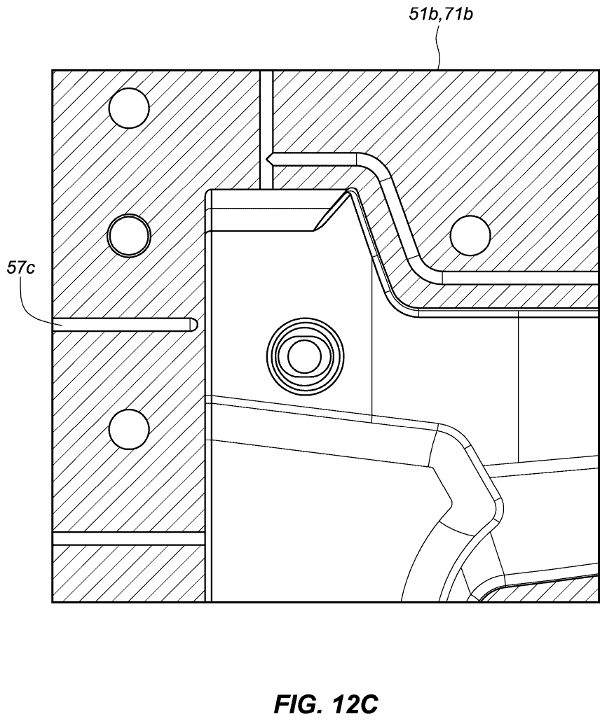

layers of carbon fiber pieces 63 can turn into a jelly-like substance and will not properly set. Accordingly, embodiments of the present disclosure can include heating the carbon fiber mold 70 to a requisite temperature, before the adhesive starts to degrade, while still allowing enough time for the foam material 40 to expand. In some embodiments, the heating apparatus includes a plurality of sets of heating plates and. In some embodiments, a first set of heating plates can be heated to a temperature of 245 degrees Celsius and the carbon fiber mold 70 can be placed between the first set of heating plates for approximately 5 minutes and then removed and moved to a second set of heating plates, that are set at a lower temperature. In some embodiments, after heating the carbon fiber mold 70 in the first set of heating plates to a temperature of, 120 degrees Celsius, the carbon fiber mold 70 can be removed from the first set of heating plates and moved to the lower temperature second set of heating plates. In some embodiments, the temperature can be measured at three areas, including the forend tip 23, bottom grip 16, and buttstock 12. In some embodiments, the carbon fiber mold 70 can include temperature probe holes 57a for insertion of a temperature probe to measure the temperature. In some embodiments, as depicted in FIGS. 12A to 12C, the temperature probe can be disposed 2 millimeters away from the interior of the carbon fiber mold 70.

FIG. 12A depicts a temperature probe hole 57a for positioning a temperature probe proximate the mold cavity at the forend part of the carbon fiber mold 70. FIG. 12B depicts a temperature probe hole 57b for positioning a temperature probe proximate the mold cavity at the bottom of the grip part of the carbon fiber mold 70, and FIG. 12C depicts a temperature probe hole 57c for positioning a temperature probe proximate the mold cavity at the buttstock part of the carbon fiber mold 70. Similar temperature probe holes 57 can be incorporated into the foam mold 50, or located at other portion(s) of the carbon fiber mold 70 and/or the foam mold 50, in order to monitor the temperature for proper control of heating of the respective mold 70, 50, for the desired foam expansion, curing and bonding of the foam material and the carbon fiber material to produce the firearm stock 10.

In some embodiments, the lower temperature second set of heating plates can be pre-heated to a temperature of 125 degrees Celsius. The carbon fiber mold 70 can be disposed between the lower temperature second set of heating plates for approximately 25 minutes, in some embodiments. In some embodiments, once the temperature drops to below 50 degrees Celsius in, for example the buttstock 12 area of the mold (e.g., measured with a buttstock temperature probe), the carbon fiber mold 70 can be opened, and the carbon fiber firearm stock 10 can be released from the carbon fiber mold 70. Although two sets of heating plates are discussed herein, greater than or fewer than two sets of heating plates can be used. In some embodiments, a single set of heating plates can be used and heated to a first temperature and then cooled to a second temperature. For example, actively cooled thermal plates can be used, which can include resistive heating elements for heating and internal channels for chilled liquid for cooling. Use of such heating plates can provide for a more automated process that removes potential sources of human error. In some embodiments disclosed herein, such thermal plates can utilize a heat transfer fluid circulated in internal channels to provide heating and/or cooling of the thermal plates, in addition to or in place of resistive heating elements.

FIGS. 9A to 9C depict the firearm stock 10 after baking, in accordance with embodiments of the present disclosure. As depicted, the firearm stock 10 has been removed from one side of the carbon fiber mold 70. As can be seen, fine features 72, such as palm swell stippling 72a, stock mounting point recess 72b, forend stippling 72c, and forend mounting point recess 72d are clearly defined in the exterior shell of the firearm stock 10 with much greater detail than provided by other more traditional firearm stock building processes that utilize fiber-reinforced material (e.g., carbon fiber). Although a rifle stock is depicted, embodiments of the present disclosure can be applied to any type of firearm stock, such as a pistol, etc.

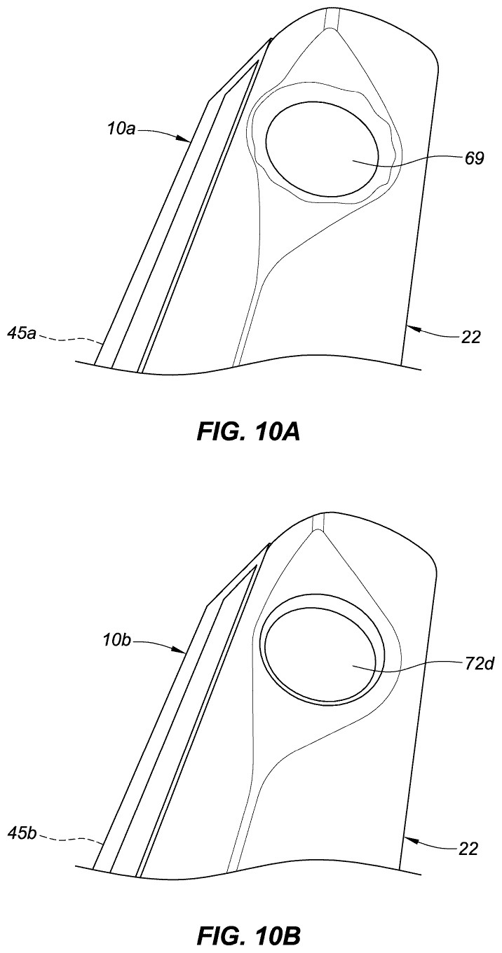

FIGS. 10A and 10B depict a forend 22 of firearm stocks 10 that are formed with different densities of foam material 40, in accordance with embodiments of the present disclosure. For example, FIG. 10A illustrates a portion of a firearm stock 10a that includes a foam core formed from a lower-density foam 45a which is less dense than that of FIG. 10B, which is formed from a higher-density foam 45b and, thereby illustrating a corresponding portion of a firearm stock 10b that includes a foam core which is more dense. By increasing the density of the foam core, as discussed herein, greater pressure can be exerted on the carbon fiber pieces 63, thereby forcing the carbon fiber pieces 63 into better contact with the carbon fiber mold 70. The improved forming of the carbon fiber pieces 63 with the greater pressure as depicted in FIG. 10B can be clearly seen over the inferior forming of the carbon fiber pieces 63 with the lesser pressure as depicted in FIG. 10A. For example, the forend mounting point recess 72d depicted in FIG. 10b has a much greater defined detail than the forend mounting point recess 69, depicted in FIG. 10A.

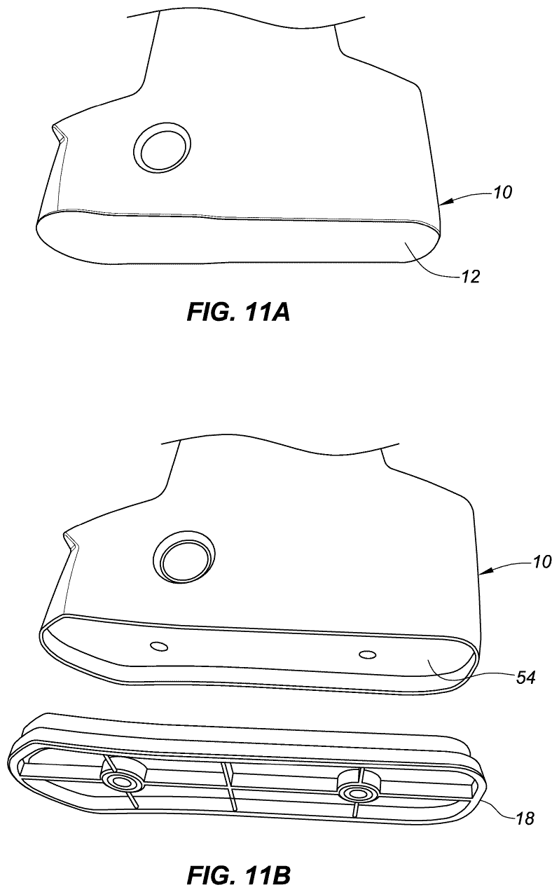

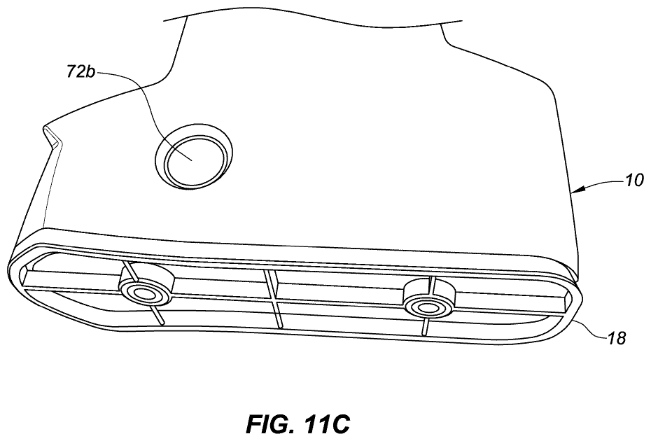

FIGS. 11A to 11C depict formation of a pocket 54 in the buttstock 12, in accordance with embodiments of the present disclosure. FIG. 11A depicts the buttstock 12 after demolding and FIG. 11B depicts the buttstock 12 after machining the pocket 54 for attachment of a buttstock shoulder insert 18. FIG. 11C depicts the buttstock shoulder insert 18 inserted into the pocket 54. As depicted and discussed herein, for example, in relation to FIG. 51, the additional layers of carbon fiber pieces 63 at the proximal end of the buttstock portion 12 can create a thicker carbon shell at the proximal end of the firearm stock, thereby allowing for an interior portion of the buttstock located between the thicker carbon shell to be machined to create a negative space in which the polymer insert can be inserted.

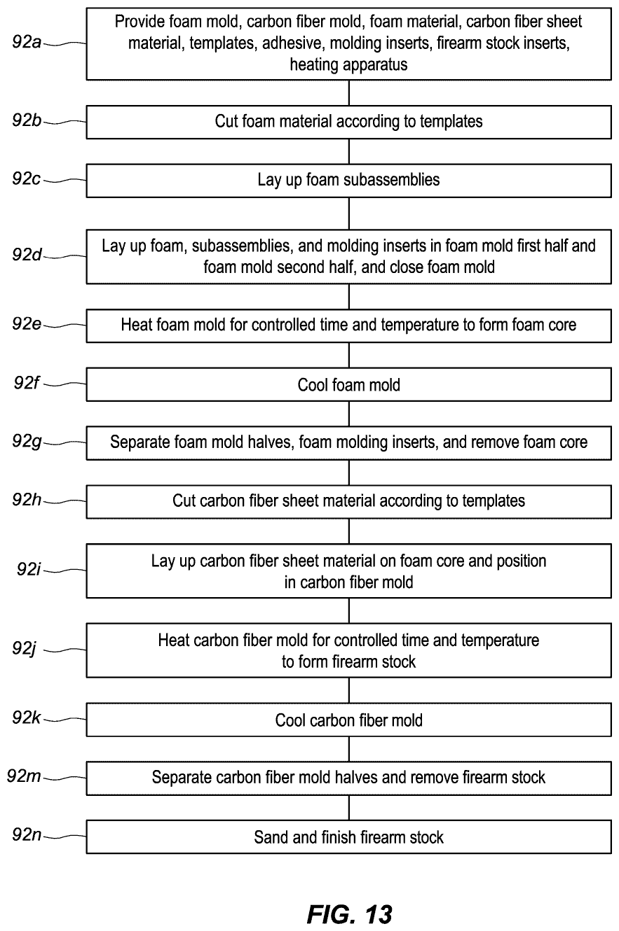

Embodiments described herein include methods of making a firearm stock 10. An exemplary method illustrated in FIG. 13 includes the steps of 92a) providing a foam mold 50, a carbon fiber mold 70, heat-activated foam material 40, heat-activated fiber-reinforced sheet material 60, templates 48, adhesive 49, molding inserts 52, firearm stock inserts 28, and heating apparatus; 92b) cutting the foam material 40 according to templates 48; 92c) laying up foam subassemblies 44; 92d) laying up foam material 40, foam subassemblies 44, and molding inserts 52 in foam mold first half 51a and foam mold second half 51b, and closing the foam mold; 92e) using the heating apparatus to heat the foam mold 50 for a controlled time and temperature to form a foam core 58; 92f) cooling the foam mold 50; 92g) separating the foam mold first half 51a and foam mold second half 51b, molding inserts 52, and removing the foam core from the foam mold 50; 92h) cutting the fiber-reinforced sheet material 60 according to templates 48; 92i) laying up pieces of the fiber-reinforced sheet material 60 on the foam core 58 and position in the carbon fiber mold 70; 92j) using the heating apparatus to heat the carbon fiber mold for controlled time and temperature to form a firearm stock; 92k) cooling the carbon fiber mold; 92m) separating the carbon fiber mold first half 71a and carbon fiber mold second half 71b and remove firearm stock 10; and 92n) sand and finish firearm stock. Other methods consistent with embodiments disclosed herein are defined by the attached claims.

Embodiments described herein include a firearm stock made by the aforementioned process.

One object of the present invention is to provide an efficient method of manufacturing a lightweight carbon-fiber firearm stock, including fine details such as narrow features, stippling, and the like.

Embodiments are described herein of various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it may be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment(s) is included in at least one embodiment. Thus, appearances of the phrases “in various embodiments,” “in some embodiments,” “in one embodiment,” or “in an embodiment,” or the like, in places throughout the specification, are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although at least one embodiment for a carbon fiber firearm stock has been described above with a certain degree of particularity, those skilled in the art could make numerous alterations to the disclosed embodiments without departing from the spirit or scope of this disclosure. All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the devices. Joinder references (e.g., affixed, attached, coupled, connected, and the like) are to be construed broadly and may include intermediate members between a connection of elements and relative movement between elements. As such, joinder references do not necessarily infer that two elements are directly connected and in fixed relationship to each other. It is intended that all matter contained in the above description or shown in the accompanying drawings shall be interpreted as illustrative only and not limiting. Changes in detail or structure may be made without departing from the spirit of the disclosure as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Reference throughout the specification to “various embodiments,” “some embodiments,” “one embodiment,” “an embodiment,” “an exemplary embodiment,” or the like, means that a particular feature, structure, or characteristic described in connection with the embodiment is included in at least one embodiment. Thus, appearances of the phrases “in various embodiments,” “in some embodiments,” “in one embodiment,” “in an embodiment,” “in an exemplary embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

As used herein, terms such as “inside”, “outside”, “inner”, “outer”, “height”, “width” “thickness”, “top”, “bottom”, “side”, “above”, “below”, and so forth generally are used herein with their ordinary meaning, consistent with the drawings herein illustrating the invention. These general direction and orientation indications are used herein for clarity of presentation, but are not necessarily intended to be limiting. For example, the “width” of an element may be longer than the “length” of the element, and “height” may be used to describe a vertical dimension of an element, but still used if in some views or embodiments that element is oriented horizontally, for consistency and clarity of presentation, unless such interpretation would be inconsistent with the teachings of the present disclosure. While the arrangements described in detail herein are preferred, some disclosed elements can be oriented or ordered differently but within the scope of the present disclosure, to the extent that such variations are not illogical or non-functional, and are consistent with the teachings of the present disclosure in view of the art.

What is claimed is:

1. A method for manufacturing a carbon fiber firearm stock, comprising:
placing one or more heat-activated pieces of foam in a foam core mold;
heating the foam core mold to a first temperature for a first time to generate a foam core;
removing the foam core from the foam core mold;
laying up the foam core with heat activated carbon fiber layers to create a carbon fiber laid-up foam core;
placing the carbon fiber laid-up foam core into a carbon fiber mold; and
heating the carbon fiber mold to a second temperature for a second time to generate the carbon fiber firearm stock.

2. A method of manufacturing a carbon fiber firearm stock, comprising the steps of:
placing heat-expandable foam material in a first mold;
heating the heat-expandable foam material in the first mold for a controlled first time and first temperature to expand the heat-expandable foam material to form a foam core;
cooling the first mold and removing the foam core from the first mold;
laying up pieces of fiber-reinforced sheet material on the foam core and positioning in a second mold;
heating the fiber-reinforced sheet material on the foam core in the second mold for a controlled second time and second temperature to further expand the foam material and press the fiber-reinforced material into apposition with the second mold to shape the fiber-reinforced material according to the shape of the second mold and coalesce the fiber-reinforced sheet material together on the foam core to form a firearm stock; and
cooling the second mold and removing the firearm stock from the second mold.

3. The method of claim 2, wherein the heat-expandable foam material is selected from the group consisting of heat-expandable foam sheet material, heat-expandable foam powder material, heat-expandable foam pellet material, and heat expandable foam block material.

4. The method of claim 2, wherein the second temperature is greater than the first temperature.

5. The method of claim 2, wherein the fiber-reinforced material is a carbon fiber sheet material.

6. The method of claim 5, further comprising the steps of:
providing a firearm stock insert selected from the list consisting of a buttstock insert, an adjustable shoulder riser insert, and an accessory attachment insert;
laying up the firearm stock insert with carbon fiber sheet material; and
heating the laid-up firearm stock insert in the second mold.

7. The method of claim 2, wherein a greater amount of foam material is placed into a first portion of the first mold than in a second portion of the first mold so that upon heating, the foam material in the first portion of the first mold will expand with greater force than the foam material in the second portion of the first mold.

8. The method of claim 7, wherein the resulting firearm stock has a greater density in the first portion than in the second portion.

9. The method of claim 2, wherein foam material having a greater density is placed in a first portion of the first mold and foam material having a lesser density is placed in a second portion of the first mold so that upon heating, the foam material in the first portion of the first mold will expand with greater force than the foam material in the second portion of the first mold.

10. The method of claim 9, wherein the resulting firearm stock has a greater density in the first portion than in the second portion.

11. A firearm stock produced by the method of claim 1.

12. A firearm stock produced by the method of claim 2.

13. The firearm stock of claim 12, wherein the firearm stock has a greater density in a first portion than in a second portion.

14. The firearm stock of claim 12, further including a firearm stock insert selected from the list consisting of a buttstock insert, an adjustable shoulder riser insert, and an accessory attachment insert.

15. A firearm stock comprising:
a heat-expandable foam core; and
a carbon fiber shell disposed on the heat-expandable foam core.

16. The firearm stock of claim 15, wherein the heat-expandable foam core has different densities of heat-expandable foam material in different portions of the foam core.

17. The firearm stock of claim 15, wherein the heat-expandable foam is selected from the group consisting of heat-expandable foam sheet material, heat-expandable foam powder material, heat-expandable foam pellet material, and heat expandable foam block material.

18. The firearm stock of claim 15, wherein the carbon fiber shell includes pieces of carbon fiber sheet material laid up on the heat-expandable foam core.

19. The firearm stock of claim 18, wherein the carbon fiber shell includes fine surface features transferred from a mold under pressure from expansion of the heat-expandable foam core.
